(19) United States
(12) Patent Application Publication
(10) Pub. No.: US 2012/0023411 A1
(43) Pub. Date: Jan. 26, 2012

(54) APPARATUS AND METHOD FOR TRANSMITTING AND RECEIVING REMOTE USER INTERFACE DATA IN A REMOTE USER INTERFACE SYSTEM

(75) Inventors: Young-Sun RYU, Seongnam-si (KR); Young-Wan So, Gunpo-si (KR); Jae-Yeon Song, Seoul (KR)

(73) Assignee: Samsung Electronics Co., Ltd., Suwon-si (KR)

(21) Appl. No.: 13/190,159

(22) Filed: Jul. 25, 2011

(30) Foreign Application Priority Data
Jul. 23, 2010 (KR) 10-2010-0071292

(51) Int. Cl. G06F 3/01

(52) U.S. Cl. 715/740

(57) ABSTRACT

An apparatus and method is provided, in which when transmitting a remote User Interface (UI), a remote UI server may provide feedback effects associated with user inputs, such as vibrations and sound effects to a remote UI client. The remote UI client includes a web browser module for rendering and outputting UI data that is received from a remote UI server in response to a remote UI request, and requesting feedback processing for providing, to a user, a feedback effect defined in the received UI data; and a feedback processor for processing feedback data in response to a request of the web browser module, and providing the feedback effect to the user according to the processing results.

### PRIORITY

This application claims priority under 35 U.S.C. §119(a) to a Korean Patent Application filed in the Korean Intellectual Property Office on Jul. 23, 2010 and assigned Serial No. 10-2010-0071292, the entire content of which is incorporated herein by reference.

### BACKGROUND OF THE INVENTION

1. Field of the Invention

The present invention relates generally to an apparatus and method for providing a remote User Interface (UI) in a remote UI system, and more particularly, to an apparatus and method in which, when transmitting remote UI data, a remote UI server may provide feedback effects associated with user inputs, such as vibrations and sound effects by the transmission of remote UIs.

2. Description of the Related Art

In general, most devices that support interfacing with users have their own unique UIs therein. With the new trend of environments where a multiple devices are connected over one or more networks, remote UI technology has been widely applied.

Remote UI technology commonly refers to technology that allows a specific device to receive a UI from another device in a remote place, where the other device is connected to the specific device over a network. For example, when a first device receives a UI provided by a second device over a network connected to devices over a wired and/or wireless connection, and provides the UI received from the second device to a user of the second device, this UI received by the first device may be a remote UI, from the viewpoint of the first device.

The home network common example in which the remote UI technology is applied. In a home network including a digital TV, a refrigerator, a set-top box, an audio system, etc., a user may use the digital TV to control other home appliances. In this case, it may be convenient for the user to use UIs appropriate for the other home appliances.

To this end, each home appliance may provide its own UI to be displayed on a screen of the digital TV, and the user may control the home appliance using the displayed UI, i.e., a remote UI.

Common methods of providing a remote UI may include use of Hypertext Markup Language (HTML) and/or Dynamic Image Update.

FIG. 1 is a diagram illustrating an example of a process of transmitting remote UI data in a conventional remote UI system based on eXtensible Hypertext Markup Language (XHTML).

Referring to FIG. 1, the conventional XHTML-based remote UI system includes a Remote User Interface Server (RUIS) 110 with a web server, and a Remote User Interface Client (RUIC) 120 with a web browser. The RUIS 110 and the RUIC 120 of the remote UI system exchange information with each other according to a Hyper Text Transfer Protocol (HTTP) communication protocol.

A conventional operation of providing remote UI data will be described with reference to FIG. 1. An RUIC 120 sends a request for a Remote UI (RUI) to an RUIS 110. In response, the RUIS 110 transmits, to the RUIC 120, a remote UI that is created in an XHTML format by a web server in the RUIS 110. The RUIC 120 parses and renders the XHTML remote UI received from the RUIS 110 using a web browser therein, and displays the rendered remote UI for the user.

If a user input or a key event occurs, the web browser in the RUIC 120 internally processes the event and shows the user the processing results. If the processing results require a new remote UI or if there is a control request, the web browser in the RUIC 120 sends an HTTP request for a new UI to the RUIS 110.

The web server in the RUIS 110 sends a new UI created in an XHTML format to the web browser in the RUIC 120 according to the processing results corresponding to the request from the web browser in the RUIC 120. Then, the web browser in the RUIC 120 provides the new UI to the user.

In providing a feedback in reply to the user input, the RUIC 120 provides feedback such as vibrations and/or sound effects originating from the RUIC 120 itself. However, the RUIC 120 cannot receive such feedback information from the RUIS 110, since the current RUI standards only define screen output specification for remote UIs, and provide no definitions for screen switching and/or the feedback associated with user inputs. Since the RUIC 120 provides feedback effects associated with user inputs by itself, different RUICs may or may not provide feedback effects, even for the same remote UI. Further, different RUICs that provide feedback effects may provide different feedback effects. Therefore, from the perspective of the RUIS 110 providing the remote UI, feedback effects that are not intended or desired by a creator having created the remote UI may be provided to the users.

### SUMMARY OF THE INVENTION

An object of the present invention is to provide an apparatus and method in which when transmitting a remote UI to an RUIC in a remote UI environment, an RUIS provides feedback effects associated with user inputs along with the remote UI.

Another object of the present invention is to provide an apparatus and method for allowing an RUIS to provide the same feedback effects for the same user inputs when transmitting a remote UI to an RUIC in a remote UI environment.

In accordance with one aspect of the present invention, there is provided a remote User Interface (UI) client. The remote UI client includes a web browser module for rendering and outputting UI data that is received from a remote UI server in response to a remote UI request, and requesting feedback processing for providing, to a user, a feedback effect defined in the received UI data; and a feedback processor for processing feedback data in response to a request of the web browser module, and providing the feedback effect to the user according to the processing results.

In accordance with another aspect of the present invention, there is provided a method for processing User Interface (UI) data received from a remote UI server by a remote UI client. The method includes rendering and outputting, by a web browser module, UI data that is received from the remote UI server in response to a remote UI request; processing feedback data for providing a feedback effect defined in the received UI data; and providing the feedback effect to a user according to the processing results.

In accordance with further another aspect of the present invention, there is provided a remote User Interface (UI) server. The remote UI server includes a web server module for transmitting UI data, in which a feedback effect to be provided to a user is defined, to a remote UI client in response to a remote UI request from a web browser module in the remote UI client.

In accordance with yet another aspect of the present invention, there is provided a method for transmitting User Interface (UI) data to a remote UI client by a remote UI server. The method includes transmitting, by a web server module, UI data, in which a feedback effect to be provided to a user is defined, to the remote UI client, in response to a remote UI request from a web browser module in the remote UI client.

### BRIEF DESCRIPTION OF THE DRAWINGS

The above and other aspects, features and advantages of certain embodiments of the present invention will be more apparent from the following description taken in conjunction with the accompanying drawings, in which:

FIG. 1 is diagram illustrating an example of a process of transmitting remote UI data in a conventional XHTML-based remote UI system;

FIG. 2 is a diagram illustrating a configuration of a remote UI system for providing feedback data along with remote UI data according to an embodiment of the present invention;

FIG. 3 is a diagram illustrating a signaling flow for providing feedback data along with remote UI data in a remote UI system according to a first embodiment of the present invention;

FIG. 4 is a flowchart illustrating a control flow of an RUIC according to the first embodiment of the present invention;

FIG. 5 is a diagram illustrating a signaling flow for providing feedback effects for the entire remote UI page in a remote UI system according to a second embodiment of the present invention;

FIG. 6 is a flowchart illustrating a control flow of an RUIC according to the second embodiment of the present invention;

FIG. 7 is a flowchart illustrating a control flow of an RUIS according to the second embodiment of the present invention;

FIG. 8 is a diagram illustrating an example of a screen with a remote UI displayed on it according to the first embodiment of the present invention; and

FIG. 9 is a diagram illustrating an example of providing feedback effects for the entire remote UI page upon channel switching in a remote UI system according to the second embodiment of the present invention.

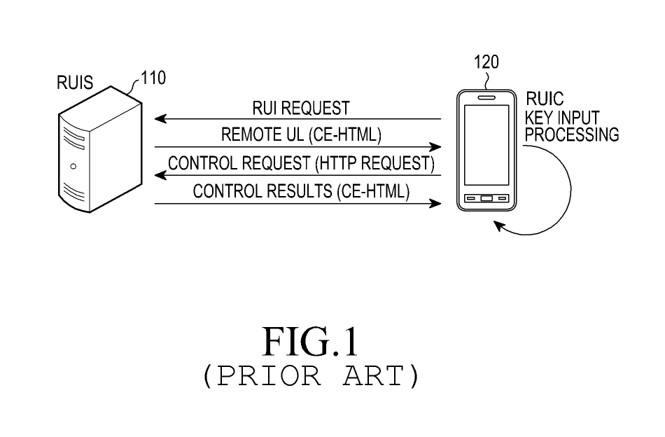

### DETAILED DESCRIPTION OF EMBODIMENTS

Embodiments of the present invention will now be described in detail with reference to the accompanying drawings. In the following description, specific details such as detailed configuration and components are merely provided to assist the overall understanding of embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

Embodiments of the present invention will be described in detail below with reference to the accompanying drawings, in which the same drawing reference numerals will be understood to refer to the same elements, features and structures.

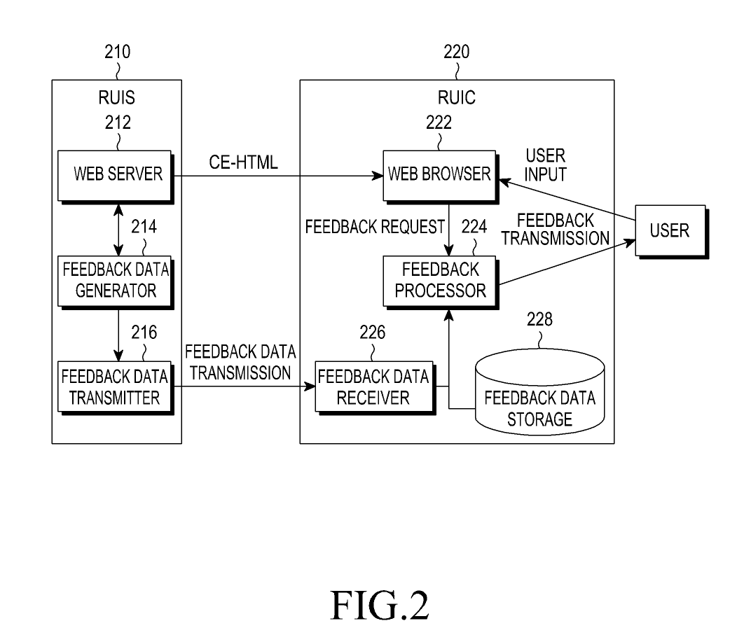

FIG. 2 illustrates a configuration of a remote UI system for providing feedback data along with remote UI data according to an embodiment of the present invention.

Referring to FIG. 2, an RUIS 210 provides remote UI data in a text format to an RUIC 220 in response to a request from the RUIC 220. To provide feedback effects associated with user inputs for a remote UI, the RUIS 210 may provide feedback data for the remote UI to the RUIC 220.

To this end, the RUIS 210 includes a web server 212, a feedback data generator 214, and a feedback data transmitter 216. The web server 212 performs an operation of providing remote UI data in a text format of XHTML, XML, etc. to the RUIC 220. In other words, the web server 212 provides remote UI data corresponding to a request from the RUIC 220, to the RUIC 220.

The feedback data generator 214 generates raw data for feedback effects, which may be stored in a storage device in the RUIS 210 in advance, in a format such as a binary file, for example.

The feedback data transmitter 216 transmits, to the RUIC 220, the raw data for feedback effects, which is generated in the feedback data generator 214 or stored in the storage device in advance.

The RUIC 220 sends a request for remote UI data to the RUIS 210, receives and renders remote UI data that is provided from the RUIS 210 in response to the request, and displays a UI for a user. The RUIC 220 provides the user with feedback effects associated with user inputs received through the displayed UI. The feedback effects provided to the user are determined based on the feedback data provided from the RUIS 210.

To this end, the RUIC 220 includes a web browser 222, a feedback processor 224, and a feedback data receiver 226. The web browser 222 sends a request for remote UI data to the RUIS 210, renders the remote UI data provided from the RUIS 210 in response to the request, and displays a user interface (such as an XHTML page, etc.). The web browser 222 also handles user input.

The feedback processor 224 processes feedback effects defined in the remote UI received from the RUIS 210, and provides the processing results to the user. The feedback processor 224 may receive feedback data from the RUIS 210, or read feedback data stored in advance, and process the feedback data according to the feedback processing defined in the remote UI. When the feedback processor 224 reads feedback data stored in advance, the feedback processor 224 may process feedback data corresponding to a feedback data IDentifier (ID) received from the RUIS 210, among the feedback data that was stored in advance after being received in a predefined type of an ID. To this end, the RUIC 220 may include a feedback data storage 228 for storing feedback data. In some cases, the feedback processor 224 may generate a new communication channel to the RUIS 210, receive raw data for feedback effects from the RUIS 210 over the generated communication channel, and process the received raw data. The reception of the raw data may be handled by the feedback data receiver 226.

A method of creating a remote UI for providing feedback effects may include a method of defining feedback effects on a target element basis, and a method of defining feedback effects for the entire remote UI page.

Examples of feedback effects according to embodiments of the present invention may include haptic effects delivering vibrations as feedback for user inputs, sound effects delivering audio feedback, image effects showing the feedbacks through displayed images, and video effects showing the feedback through displayed videos. The feedback effects provided by the present invention are not limited thereto, and any feedback effects other than the above-listed ones may be applied to embodiments of the present invention. Multiple feedback effects may also be simultaneously provided to the user.

The objects, for which feedback effects may be displayed, may include a state of a remote UI, a button, an anchor, and content, for example. The state of a remote UI refers to a notification of an error before or after the remote UI is loaded. The button refers to the case where a user selects a button displayed for by rendering the remote UI. The anchor refers to the case where content provided by the remote UI is connected to another link through a hypertext link. The content refers to the case where content, such as audios, videos, images and texts, is displayed in a user screen. In addition to examples of the objects described herein, for which feedback effects may be displayed, other objects may correspond to feedback effects in accordance with embodiments of the present invention.

Different methods of providing feedback effects in an XHTML-based remote UI system according to embodiments of the present invention are described in detail herein as follows.

In a first embodiment of the present invention, feedback effects are defined in units of target elements (or tags) included in a remote UI. To this end, information for providing feedback effects for user inputs is described as additional information of attributes for the target elements. The target elements, for which feedback effects will be provided, may include all elements capable of processing user inputs, such as <button>, <image>, <a>, and <object>.

Information added to the attributes may include EffectType, EffectID, EffectTime, etc. EffectType may include haptic, sound, image, video, etc. EffectID may be an ID for a predefined feedback effect. EffectTime is information about the time, for which feedback effects are provided, and may represent the time for which the feedback effects last, and a difference between the time a user input is made and the time the feedback effects start to be provided. This additional information is a mere example, and a variety of other additional information may be added. Names of the additional information are subject to change.

Table 1 below shows an example of feedback effects defined according to the first embodiment of the present invention.

TABLE 1
1) <button EffectType=”haptic” EffectID=”2”>
2) <a href=”uri” EffectType=”sound” EffectID=”1”>
3) <image src=”image.jpg” EffectType=”haptic+sound” EffectID=”2+1”>

Regarding the first item in Table 1, for an element <button>, its attributes EffectType and EffectID are designated as “haptic” and “2”, respectively. In this case, if the user selects the button, a vibration effect of ‘2’, which was designated as the button's feedback effect in advance, is provided. The vibration effect of ‘2’ is raw data that was stored in the feedback data storage 223 in advance, and various vibration patterns may be provided in accordance with embodiments of the present invention.

Regarding the second item of Table 1, for an element <a>, its attributes EffectType and EffectID are designated as “sound” and “1”, respectively. In this case, if the user selects a hyperlink, the sound effect of ‘1’ (i.e., a selected audio file corresponding to the selected number ‘1’) is provided to the user and thereafter, the next operation, or connection to the link, is performed.

Regarding the third item of Table 1, in which both of the two effects are applied, for an element <image>, its attributes EffectType and EffectID are designated as “haptic+sound” and “2+1”, respectively. In this case, if the user selects the image, the vibration effect of ‘2’ and the sound effect of ‘1’ are simultaneously provided to the user.

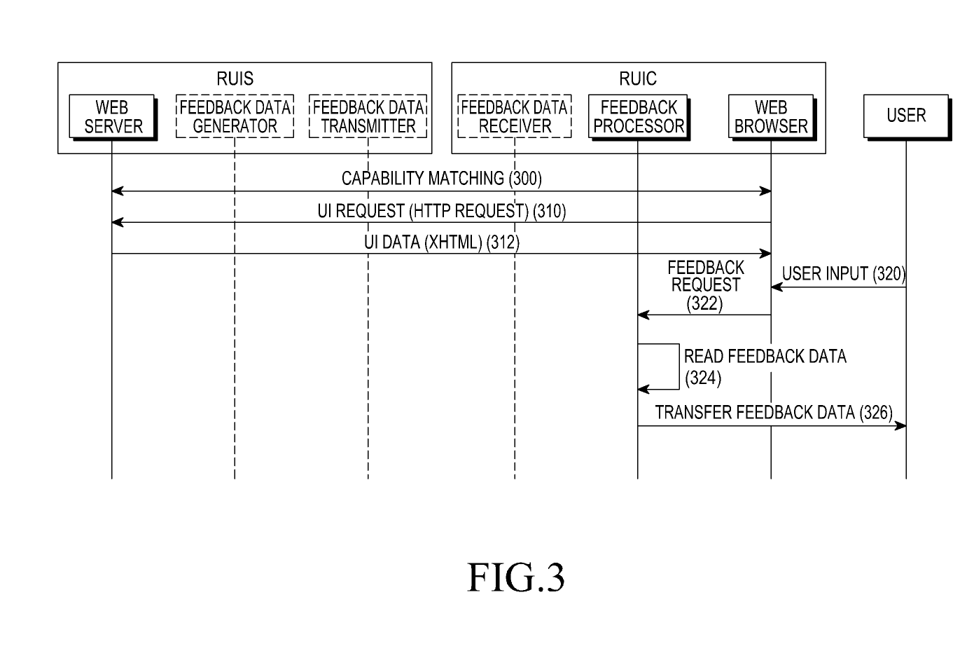

FIG. 3 illustrates a signaling flow for providing feedback data on a target element basis in a remote UI system according to the first embodiment of the present invention.

Referring to FIG. 3, in step 300, a web server 212 in an RUIS 210 and a web browser 222 in a RUIC 220 perform a capability matching process of checking a feedback effect handling capability of the RUIC 220, before requesting and transmitting a remote UI. In other words, the RUIS 210 checks whether the RUIC 220 is a device capable of providing vibration effects, sound effects, etc., and describes the feedback effects the RUIC 220 may handle, in the remote UI according to the check results.

In step 310, the web browser 222 in the RUIC 220 requests the web server in the RUIS 210 to provide remote UI data by transmitting an HTTP request.

In step 312, the web server 212 in the RUIS 210 transmits remote UI data corresponding to the HTTP request to the web browser 222 in the RUIC 220. The transmitted remote UI data may include a description for feedback effects for each element. A typical example of the remote UI data created based on the text format may include an XHTML page created based on XHTML.

Upon receiving the remote UI data in the text format, the web browser 222 in the RUIC 220 parses and renders the received remote UI data, and provides the UI to the user.

If an event caused by a particular user input occurs in step 320, the web browser 222 checks attributes described for an element corresponding to the user input, and sends a feedback processing request to a feedback processor 224 in step 322.

In step 324, the feedback processor 224 checks attributes for the element and reads feedback data stored in the feedback data storage 228 according to the attribute information such as EffectType, EffectID, and EffectTime. In step 326, the feedback processor 224 processes the read feedback data and provides the feedback effects to the user.

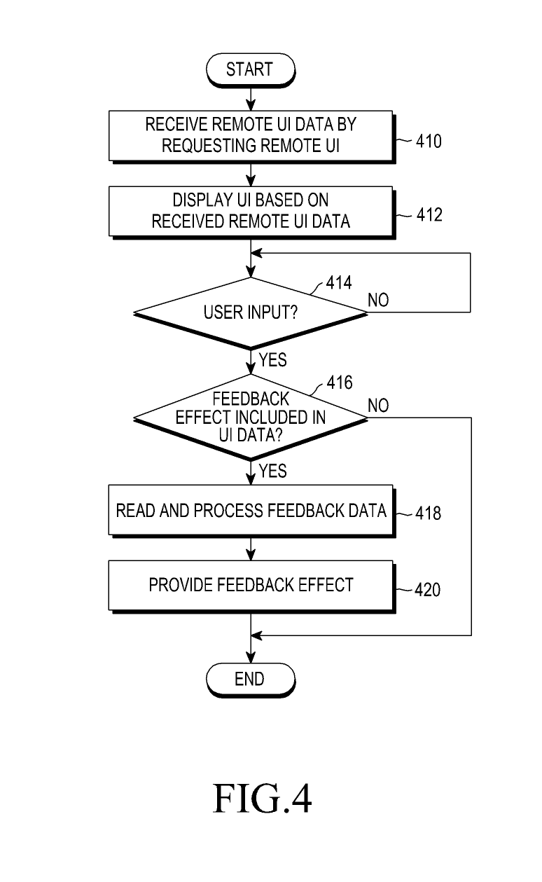

FIG. 4 illustrates a control flow performed by an RUIC according to the first embodiment of the present invention. An operation corresponding to steps 410 to 416 in FIG. 4 is performed by a web browser 222 in the RUIC 220, and an operation corresponding to steps 418 and 420 is performed by a feedback processor 224 in the RUIC 220.

In the following description of an operation of the RUIC 220 according to an embodiment of the present invention, the web browser 222 in the RUIC 220 performs communication with a web server 212 in an RUIS 210, and the feedback processor 224 in the RUIC 220 performs communication with the web browser 222 in the RUIC 220.

Therefore, although it will be assumed in the following description that the RUIC 220 is described as the entity that performs operations corresponding to all of the steps illustrated in FIG. 4, it should be construed that actually, the operations are performed by the above-defined entities on an individual basis.

Referring to FIG. 4, as an operation by the RUIC 220 starts, the RUIC 220 receives remote UI data from an RUIS 210 in step 410 and provides a UI to the user in step 412. The remote UI data provided from the RUIS 210 is remote UI data in a text format, which can be provided in an initial operation. The remote UI data in the text format may include a UI created in XHTML.

In step 410, the RUIC 220 sends a request for a UI in a text format to the RUIS 210, and receives remote UI data that is provided from the RUIS in response to the request in a text format. In step 412, the RUIC 220 parses and renders the received remote UI, and displays the parsed and rendered UI on a user interface including a display unit.

In step 414, the RUIC 220 checks whether a user input event occurs. If there user input is received, the RUIC 220 checks, in step 416, whether a description for providing feedback effects is included in the received remote UI data.

If a description for providing feedback effects is included in the received remote UI data, the RUIC 220 reads feedback data associated with the user input from its feedback data storage 228 and processes the read feedback data in step 418. In step 420, the RUIC 220 provides the feedback effects to the user according to the processing results. However, if a description for providing feedback effects is not included in the received remote UI data, the RUIC ends the operation.

Although not illustrated in FIG. 4, if the feedback data associated with the user input made in step 414 is not stored in the feedback data storage 228, the RUIC 220 may send a request for feedback data to the RUIS 210, and receive and process the requested feedback data, thereby providing feedback effects to the user. This operation is described in detail below in with respect to a second embodiment of the present invention.

In the second embodiment of the present invention, feedback is defined for the entire remote UI page. In other words, an RUIS 210 defines the feedback for the entire remote UI page so that an RUIC 220 may provide feedback effects to the user before the remote UI is loaded, or if a notification such as an error occurs in the remote UI, the RUIC 220 may provide feedback effects for the notification.

A feedback defining method according to the second embodiment of the present invention, in which feedback is defined for the entire XHTML page, is described as follows.

Table 2 below shows an example of feedback effects defined according to the second embodiment of the present invention.

TABLE 2

<head>
<object id=“rf” type=“application/feedback”>
<object id=“ns” type=“application/notifsocket”>
function preload_init( )
{
//Method #1
var EffectType = “haptic”;
var EffectID = 2;
rf.EffectPlay(EffectType, EffetID, 0);
//Method #2
var feedbackdata = ns.getData;
rf.EffectPlay(“haptic”,0,feedbackdata);
</head>
<body onload=“preload_init( )”>
</body>

With reference to Table 2, a method of defining feedback for the entire remote UI page, in which feedback effects are performed before the remote UI page is loaded, is described as follows.

If the feedback effects are provided before the remote UI page is loaded as in Table 2, the waiting time for feedback effects perceived by the user may be reduced, when loading of a remote UI page such as channel switching takes a long time.

In Table 2, a method (Method #1) of using feedback data that was stored in an RUIC 220 in advance using an ID, and a method (Method #2) of receiving feedback data from an RUIS 210 are described as a method of providing feedback effects for the entire remote UI page.

Method #1 is similar to the method described with reference to Table 1 according to the first embodiment of the present invention. Since attributes EffectType and EffectID are designated as “haptic” and “2”, respectively, the vibration effect of ‘2’, which was designated as a feedback effect in advance, is provided to the user when the remote UI page is loaded.

In Method #2, the RUIC 220 receives raw data used for providing feedback effects from the RUIS 210, instead of using the feedback data that was defined and stored in advance. According to this method, the RUIS 210 may provide the RUIC 220 with new feedback effects that are not defined in advance. According to embodiments of the present invention, as a transmission means for transmitting feedback data to the RUIC 220, the RUIS 210 may use the well-known XMLHttpRequest, or may generate a separate communication channel (e.g., such as through a TCP/IP Connection) such as a Notification socket, and transmit feedback data through the communication channel. However, according to embodiments of the present invention, various transmission means may be used to transmit feedback data.

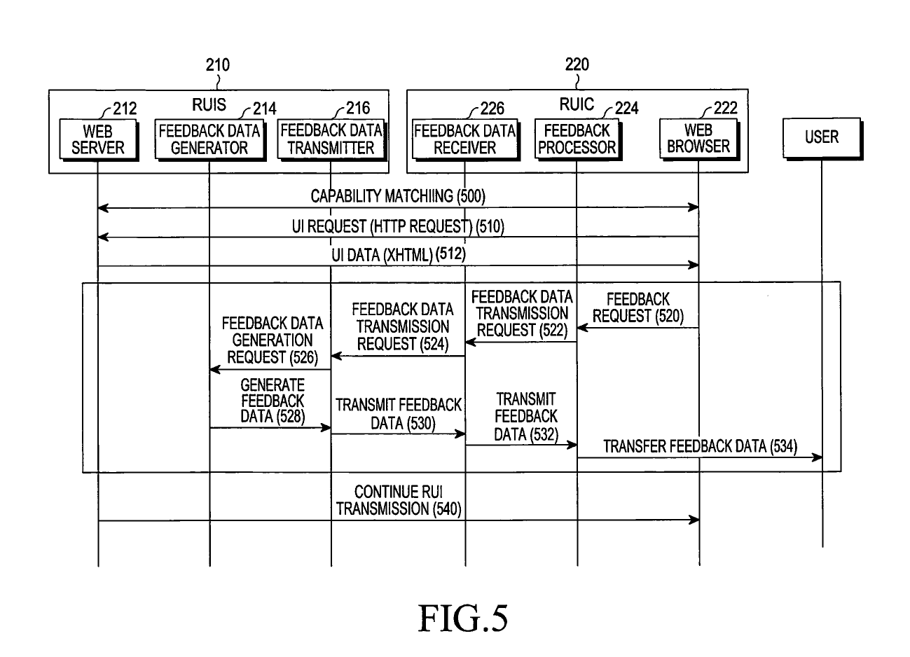

FIG. 5 illustrates a signaling flow for providing feedback effects for the entire remote UI page in a remote UI system according to a second embodiment of the present invention, in which an RUIC 220 receives feedback data from an RUIS 210 and provides feedback effects to a user before loading of a remote UI page, such as channel switching, is completed.

Referring to FIG. 5, in step 500, a web server 212 in an RUIS 210 and a web browser 222 in an RUIC 210 perform a capability matching process of checking a feedback effect handling capability of the RUIC 220, before requesting and transmitting a remote UI. In other words, the RUIS 210 checks whether the RUIC is capable of providing vibration effects, sound effects, etc., and describes the feedback effects the RUIC 220 may handle, in the remote UI according to the check results.

In step 510, the web browser 222 in the RUIC 220 requests the web server 212 in the RUIS 210 to provide remote UI data by transmitting an HTTP request.

In step 512, the web server in the RUIS 210 transmits remote UI data corresponding to the HTTP request to the web browser 222 in the RUIC 220. The transmitted remote UI data may include a description for providing feedback effects for the entire remote UI page. The transmitted remote UI data is an initial XHTML configuration file (the same concept as index.html) for creating the entire remote UI, and may not necessarily mean the completed transmission of all remote UI data of the remote UI.

Upon receiving the remote UI data in the text format from the web server 212 in the RUIS 210, the web browser 222 in the RUIC 220 parses the received remote UI data. If a description of feedback effects is included in the remote UI data, the web browser 222 in the RUIC 220 sends a feedback processing request to a feedback processor 224 in step 520.

If the feedback processor 224 requests a feedback data receiver 226 to transmit feedback data in step 522, the feedback data receiver 226 re-requests a feedback data transmitter 216 in the RUIS 210 to transmit feedback data, in step 524.

Upon receiving the feedback data transmission request from the RUIC 220, the feedback data transmitter 216 requests a feedback data generator 214 to generate feedback data in step 526. In step 528, the feedback data generator 214 generates feedback data and transfers the feedback data to the feedback data transmitter 216. In step 530, the feedback data transmitter 216 transmits the feedback data received from the feedback data generator 214 to the feedback data receiver 226 in the RUIC 220.

Upon receiving the feedback data, the feedback data receiver 226 transmits the received feedback data to the feedback processor 224 and requests feedback processing in step 532. Then, in step 534, the feedback processor 224 processes the feedback data, and provides feedback effects to the user according to the processing results.

Even while the feedback data is transmitted/received and processed in steps 520 to 534, the remote UI data may be continuously transmitted from the web server 212 in the RUIS 210 to the web browser 222 in the RUIC 220 in step 540. Because the feedback data handling process of steps 520 to 534 may be performed separately from the operation of the web browser in this way, the feedback effects may be provided to the user before the UI page is loaded, allowing the user experience a reduced waiting time.

If the RUIC 220 uses the UI data stored in advance using EffectID, such as Method #1 of Table 2, the RUIC 220 does not need to receive feedback data from the RUIS 210. Therefore, upon receiving the feedback processing request in step 520, the feedback processor 224 reads the UI data stored in the feedback data storage 228 and processes the read UI data, instead of requesting the feedback data receiver 226 to transmit feedback data in step 522, and then provides feedback effects to the user according to the processing results in step 534. In other words, the operation of steps 522 to 532 is disabled.

The RUIC 220 may store the feedback data received from the RUIS 210 in a temporary storage. In this case, in processing the same feedback data, the feedback processor in the RUIC 220 may read the feedback data stored in the temporary storage and process the read feedback data, instead of requesting the feedback data receiver 226 to transmit feedback data, thereby reducing the feedback data processing time.

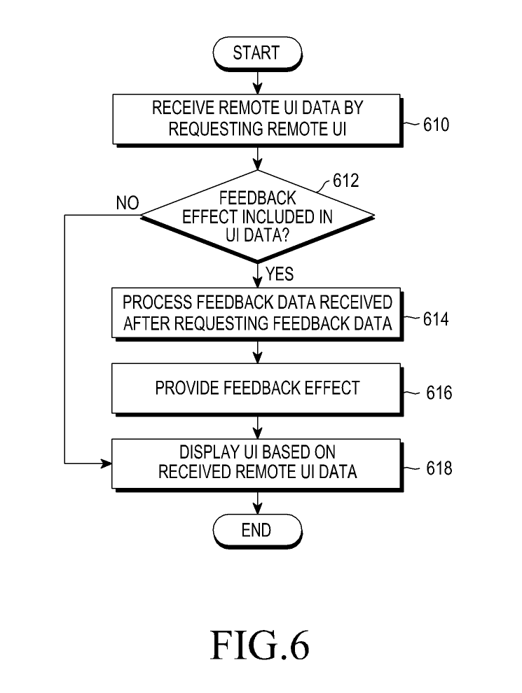

FIG. 6 illustrates a control flow performed by an RUIC 220 according to the second embodiment of the present invention. Operations corresponding to steps 610, 612 and 618 in FIG. 6 are performed by a web browser 222 in the RUIC 220, and operations corresponding to steps 614 and 616 are performed by a feedback processor 224 and a feedback data receiver 226 in the RUIC 220.

In the following description of an operation of an RUIC according to an embodiment of the present invention, the web browser in the RUIC 220 communicates with a web server 212 in an RUIS 210, the feedback data receiver 226 in the RUIC 220 performs communication with a feedback data transmitter 216 in the RUIS 210, and the feedback processor 224 in the RUIC 220 performs communication with the web browser 222 and the feedback data receiver 226 in the RUIC 220.

Therefore, although in the following description, the RUIC 220 is described as the entity performing operations corresponding to all steps, the operations are actually performed by the above-defined entities on an individual basis.

Referring to FIG. 6, as an operation by the RUIC 220 starts, the RUIC 220 receives remote UI data from an RUIS 210 and provides a UI to the user in steps 610 and 618. The remote UI data provided from the RUIS refers remote UI data in a text format, which can be provided in an initial operation. An example of the remote UI data in the text format may include a UI created in XHTML.

To this end, in step 610, the RUIC 220 sends a request for a UI to the RUIS 210, and receives remote UI data, which is provided from the RUIS 210 in response to the request. In step 612, the RUIC 220 checks whether a description for providing feedback effects is included in the received remote UI data.

If a description for providing feedback effects is included in the received remote UI data, the RUIC 220 sends a request for feedback data to the RUIS 210, receives and processes the requested feedback data in step 614, and provides feedback effects to the user according to the processing results in step 616.

Even while the feedback data is transmitted/received and processed, the RUIC 220 may continuously receive the remote UI data from the RUIS 210. After providing feedback effects, the RUIC 220 parses and renders the received remote UI, and displays the parsed and rendered UI on a user interface including a display unit in step 618.

However, if a description for providing feedback effects is not included in the remote UI data received from the RUIS 210 in step 612, the RUIC 220 parses and renders the received remote UI, and displays the parsed and rendered UI on a user interface including a display unit in step 618.

If the RUIC 220 uses the UI data stored in advance using EffectID, such as in Method #1 of Table 2, the RUIC 220 does not need to receive feedback data from the RUIS 210. Therefore, the RUIC 220 reads the UI data stored in the feedback data storage and processes the read UI data in step 614, and then provides feedback effects to the user according to the processing results in step 616.

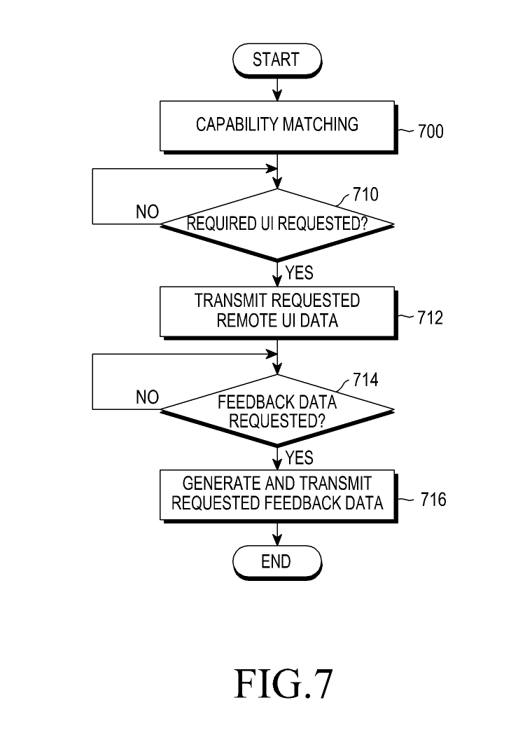

FIG. 7 illustrates a control flow performed by an RUIS 210 according to the second embodiment of the present invention. Operations corresponding to steps 700 to 712 in FIG. 7 are performed by a web server 212 in the RUIS 210, and operations corresponding to steps 714 and 716 are performed by a feedback data generator 214 and a feedback data transmitter 216 in the RUIS 210.

In the following description of operations of an RUIS 210 according to an embodiment of the present invention, the web server 212 in the RUIS 210 performs communication with a web browser 222 in an RUIC 220, the feedback data transmitter 216 in the RUIS 210 performs communication with a feedback data receiver 226 in the RUIC 220, and the feedback data generator 214 in the RUIS 210 performs communication with the feedback data transmitter 216 in the RUIS 210.

Therefore, although in the following description, the RUIS described as the entity performing the operations corresponding to all steps, the operations are actually performed by the above-defined entities on an individual basis.

Referring to FIG. 7, in step 700, the RUIS 210 performs a capability matching process of checking a feedback effect handling capability of an RUIC 220, before transmitting a remote UI upon request. In other words, the RUIS 210 checks whether the RUIC 220 is a device capable of providing vibration effects, sound effects, etc, and describes the feedback effects the RUIC 220 may handle, in the remote UI according to the check results.

In step 710, the RUIS 210 monitors whether a request for a remote UI is received from the RUIC. Upon receiving a remote UI request from the RUIC 220, the RUIS 210 transmits the remote UI data requested by the RUIC 220 to the RUIC 220, in step 712. The remote UI data may be generated at the request of the RUIC 220, or may be generated in the RUIS 210 in advance. The remote UI data may include a UI created in XHTML.

In transmitting the remote UI data, the RUIS 210 includes therein a description for providing feedback effects. In step 714, the RUIS 210 monitors whether a feedback data transmission request is received from the RUIC 220. Upon receiving a feedback data transmission request from the RUIC 220, the RUIS 210 generates feedback data requested by the RUIC 220 and transmits the generated feedback data to the RUIC 220, in step 716.

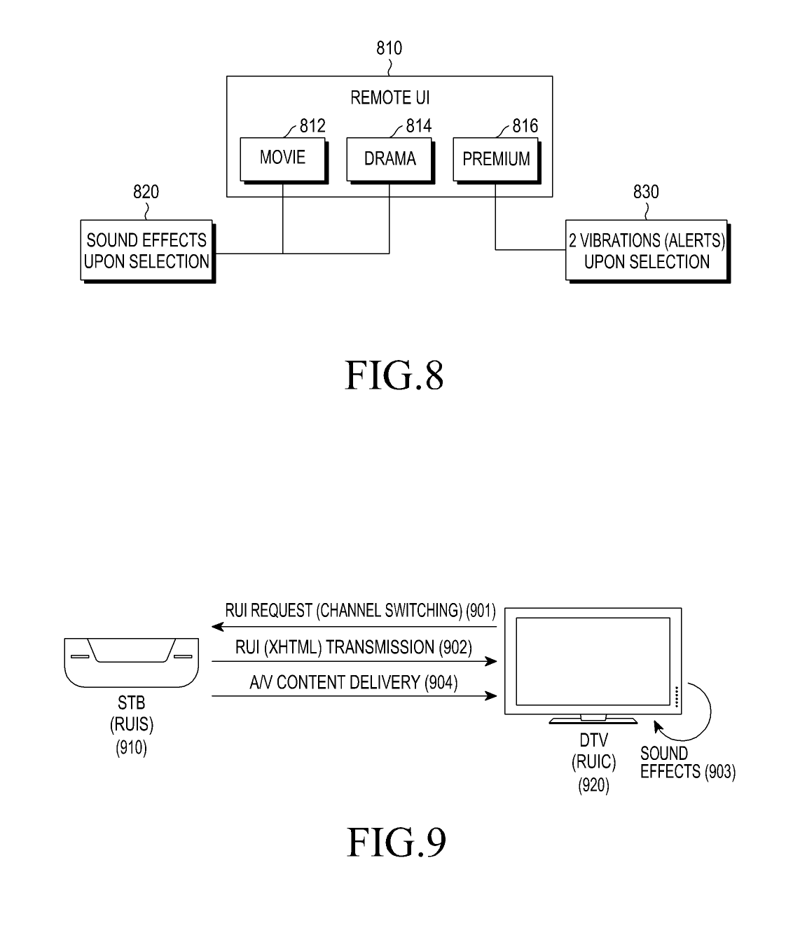

FIG. 8 is a diagram illustrating an example of a screen with a remote UI displayed thereon according to the first embodiment of the present invention.

As illustrated in FIG. 8, three menus ‘Movie’ 812, ‘Drama’ 814, and ‘Premium’ 816 are displayed on the screen, and when the menus are selected by user inputs, different feedback effects, such as sound effects 820 and vibrations 830, may be provided for the respective menus. For example, assume that there are no special constraints when Movie 812 and Drama 814 are selected, and there are special constraints such as billing when Premium 816 is selected. If Movie 812 and Drama 814 are selected, simple sound effects may be provided to indicate the selection of the menus. Unlike Movie 812 and Drama 814, however, if Premium 816 is selected, vibration effects 830 may be additionally provided to inform the user of the selection of the menu, for the purpose of warning.

FIG. 9 is a diagram illustrating an example of providing feedback effects for the entire remote UI page upon channel switching in a remote UI system according to the second embodiment of the present invention.

Referring to FIG. 9, if a Digital TV (DTV) 920 serving as an RUIC sends a request for remote UI data corresponding to channel switching to a Set-Top Box (STB) 910 serving as an RUIS, the STB 910 transmits the requested remote UI data to the DTV 920. Before transmitting the entire remote UI data, the STB 910 transmits feedback data for providing feedback effects for the channel switching. Therefore, before displaying the UI screen, the DTV 920 processes the feedback data received from the STB 910 and provides feedback effects such as sound effects to the user. Thereafter, the STB 910 transmits channel switching-related UI data to the DTV 920, thereby providing audio/video content.

As to another example of providing feedback effects to a user, sound effects designated in advance may be provided to the user even when services requested by the RUIC 220, such as Consumer Electronics HTML (CE-HTML) and Capability Matching, may not be provided. In addition, upon mail arrival and/or occurrence of an important 3rd party notification, sound effects may be provided to the user.

As is apparent from the foregoing description, according to embodiments of the present invention, in the remote UI environment, an RUIS may provide feedback effects associated with user inputs along with a remote UI when transmitting the remote UI to an RUIC, thereby providing the user with the feedback effects meeting the intention to provide the remote UI.

Furthermore, in a remote UI environment, when transmitting a remote UI to the RUIC 220, the RUIS 210 may provide the same feedback effects for the same user inputs.

Besides, in a remote UI environment, when transmitting a remote UI to the RUIC 220, the RUIS 210 may transmit feedback data along with the remote UI, thereby reducing the waiting time the user may feel during, for example, channel switching.

While embodiments of the present invention have been shown and described with reference to certain embodiments thereof, it will be understood by those skilled in the art that various changes in form and details may be made therein without departing from the spirit and scope of the invention as defined by the appended claims and their equivalents.

What is claimed is:

1. A remote User Interface (UI) client comprising:
a web browser module for rendering and outputting UI data that is received from a remote UI server in response to a remote UI request, and requesting feedback processing for providing, to a user, a feedback effect defined in the received UI data; and
a feedback processor for processing feedback data in response to a request of the web browser module, and providing the feedback effect to the user according to the processing results.

2. The remote UI client of claim 1, further comprising a feedback data storage for storing the feedback data,
wherein the feedback data is predefined according to an agreement with the remote UI server and stored in the feedback data storage, and
wherein an IDentifier (ID) of the feedback data is included in the received UI data.

3. The remote UI client of claim 1, further comprising a feedback data receiver for sending a request for the feedback data to the remote UI server and receiving the feedback data from the remote UI server in response to a request of the feedback processor, and transmitting the received feedback data to the feedback processor.

4. The remote UI client of claim 3, further comprising a temporary storage for temporarily storing feedback data received from the remote UI server.

5. The remote UI client of claim 1, wherein upon detecting input from the user, the web browser module requests the feedback processor to perform feedback processing for providing a feedback effect associated with the input.

6. The remote UI client of claim 1, wherein the received UI data includes data for providing a feedback effect for each target element displayed on a screen.

7. The remote UI client of claim 6, wherein the element includes at least one of a state of a remote UI, a button, an anchor, and content.

8. The remote UI client of claim 1, wherein the received UI data includes data for providing a feedback effect for an entire displayed screen, and the feedback effect is provided before the UI data is output.

9. The remote UI client of claim 1, wherein the received UI data includes feedback data for providing a feedback effect indicating a specific event, which occurs after a UI to be displayed is displayed on a screen.

10. The remote UI client of claim 1, wherein the feedback effect includes at least one of a vibration effect, a sound effect, an image, and a video.

11. A method for processing User Interface (UI) data received from a remote UI server by a remote UI client, comprising:
rendering and outputting, by a web browser module, UI data that is received from the remote UI server in response to a remote UI request;
processing feedback data for providing a feedback effect defined in the received UI data; and
providing the feedback effect to a user according to the processing results.

12. The method of claim 11, wherein the feedback data is predefined according to an agreement with the remote UI server and stored in the remote UI client, and an Identifier (ID) of the feedback data is included in the received UI data;
wherein the processing of feedback data comprises reading feedback data corresponding to the ID among the stored feedback data, and processing the read feedback data.

13. The method of claim 11, wherein processing the feedback data comprises requesting the remote UI server to provide the feedback data, receiving the requested feedback data from the remote UI server, and processing the received feedback data.

14. The method of claim 11, wherein processing the feedback data comprises, upon detecting an input from the user, processing feedback data for providing a feedback effect associated with the input, among feedback effects defined in the received UI data.

15. The method of claim 11, wherein the received UI data includes data for providing a feedback effect for each target element displayed on a screen.

16. The method of claim 15, wherein the element includes at least one of a state of a remote UI, a button, an anchor, and content.

17. The method of claim 11, wherein the received UI data includes data for providing a feedback effect for an entire displayed screen, and the feedback effect is provided before the UI data is output.

18. The method of claim 11, wherein the received UI data includes feedback data for providing a feedback effect indicating a specific event, which occurs after a UI to be displayed, is displayed on a screen.

19. The method of claim 11, wherein the providing of the feedback effect comprises providing at least one of a vibration effect, a sound effect, an image, and a video to the user.

20. A remote User Interface (UI) server comprising:
a web server module for transmitting UI data, in which a feedback effect to be provided to a user is defined, to a remote UI client in response to a remote UI request from a web browser module in the remote UI client.

21. The remote UI server of claim 20, wherein the web server module includes, in the UI data, an IDentifier (ID) of feedback data predefined according to an agreement with the remote UI client, and transmits the UI data to the remote UI client.

22. The remote UI server of claim 20, further comprising:
a feedback data generator for generating feedback data for providing the feedback effect; and
a feedback data transmitter for requesting the feedback data generator to generate the feedback data in response to a request of the remote UI client, and transmitting the generated feedback data to the remote UI client.

23. The remote UI server of claim 22, wherein the web server module performs a procedure for checking whether the remote UI client has a capability to provide the feedback effect, before transmitting the UI data.

24. The remote UI server of claim 22, wherein the web server module transmits to the remote UI client the UI data that includes feedback data for providing a feedback effect for an entire UI screen displayed, to the user.

25. The remote UI server of claim 22, wherein the web server module transmits to the remote UI client the UI data that includes feedback data for providing a feedback effect indicating a specific event that occurs after a UI is displayed on a screen.

26. The remote UI server of claim 20, wherein the web server module transmits, to the remote UI client, the UI data that includes feedback data for providing a feedback effect for each element in a UI displayed, to the user.

27. The remote UI server of claim 26, wherein the element includes at least one of a state of a remote UI, a button, an anchor, and content.

28. The remote UI server of claim 20, wherein the feedback effect includes at least one of a vibration effect, a sound effect, an image, and a video.

29. A method for transmitting User Interface (UI) data to a remote UI client by a remote UI server, comprising:
transmitting, by a web server module, UI data, in which a feedback effect to be provided to a user is defined, to the remote UI client, in response to a remote UI request from a web browser module in the remote UI client.

30. The method of claim 29, wherein transmitting the UI data comprises inserting, in the UI data, an IDentifier (ID) of feedback data predefined according to an agreement with the remote UI client, and transmitting the UI data to the remote UI client.

31. The method of claim 29, further comprising:
generating the feedback data in response to a request of the remote UI client; and
transmitting the generated feedback data to the remote UI client.

32. The method of claim 29, wherein transmitting the UI data comprises transmitting to the remote UI client the UI data that includes feedback data for providing a feedback effect for each element in a UI displayed, to the user.

33. The method of claim 32, wherein the element includes at least one of a state of a remote UI, a button, an anchor, and content.

34. The method of claim 29, wherein transmitting the UI data comprises transmitting to the remote UI client the UI data that includes feedback data for providing a feedback effect for an entire UI screen displayed, to the user.

35. The method of claim 29, wherein transmitting the UI data comprises transmitting to the remote UI client the UI data that includes feedback data for providing a feedback effect indicating a specific event that occurs after a UI is displayed on a screen.

36. The method of claim 29, wherein the feedback effect includes at least one of a vibration effect, a sound effect, an image, and a video.

37. The method of claim 29, further comprising performing a procedure for checking whether the remote UI client has a capability to provide the feedback effect, before transmitting the UI data.
